(19) United States
(12) Patent Application Publication
(10) Pub. No.: US 2016/0147106 A1
(43) Pub. Date: May 26, 2016

(54) DISPLAY DEVICE

(71) Applicant: Samsung Display Co., Ltd., Yongin-City (KR)

(72) Inventors: Yeun Tae KIM, Hwaseong-si (KR); Min Su KIM, Seoul (KR); Soo Jung LEE, Yongin-si (KR)

(21) Appl. No.: 14/701,224

(22) Filed: Apr. 30, 2015

(30) Foreign Application Priority Data
Nov. 26, 2014 (KR) 10-2014-0166438

(51) Int. Cl. G02F 1/1333; F21V 8/00; G02F 1/1335

(52) U.S. Cl. CPC G02F 1/133308; G02F 1/133528; G02F 1/133377; G02F 1/133345; G02F 1/133514; G02B 6/0051; G02F 1/133608; G02F 2001/133317; G02F 2202/28

(57) ABSTRACT

A display device includes: a display panel; a backlight unit formed under the display panel; and a side chassis formed to be bent over the display panel and under the backlight unit while enclosing an edge side of the display panel and the backlight unit, wherein an adhesive is filled inside the side chassis and in a space between the display panel and the backlight unit. The adhesive is filled inside the chassis formed at the edge of the panel such that damage to the display device may be prevented and durability may be improved.

### CROSS-REFERENCE TO RELATED APPLICATION

This application claims priority to and the benefit of Korean Patent Application No. 10-2014-0166438 filed in the Korean Intellectual Property Office on Nov. 26, 2014, the entire contents of which are incorporated herein by reference.

### BACKGROUND

(a) Field

The present invention relates to a display device.

(b) Description of the Related Art

A liquid crystal display (LCD) is one of the most commonly used flat panel displays. The liquid crystal display applies different potentials to a pixel electrode and a common electrode of a liquid crystal panel in which a liquid crystal layer is formed between a lower panel and an upper panel to generate an electric field, such that an arrangement of liquid crystal molecules of the liquid crystal layer is realigned and the polarization of incident light is controlled, thereby displaying images.

The two panels forming the liquid crystal panel of the liquid crystal display may be formed of the lower panel in which a thin film transistor is arranged and the upper panel facing the lower panel. A gate line transmitting a gate signal, a data line transmitting a data signal, a thin film transistor connected to the gate line and the data line, and a pixel electrode connected to the thin film transistor are formed in the lower panel. A light blocking member, a color filter, and a common electrode may be formed in the upper panel, and at least one of them may be formed in the lower panel.

In general, in the liquid crystal display, two substrates are used for the lower panel and the upper panel, and processes for forming the above-described constituent elements in each substrate and combining the two panels are required. As a result, the liquid crystal panel is heavy and thick, and cost and process time problems are recognized. Recently, a technique in which a tunnel-shaped structure is formed on one substrate and the liquid crystal is injected inside the structure to manufacture the display device has been developed.

The above information disclosed in this Background section is only for enhancement of understanding of the background of the disclosure and therefore it may contain information that does not form the prior art that is already known to a person of ordinary skill in the art.

### SUMMARY

A display device is provided in which damage to the display device is prevented and durability is improved by filling an adhesive in a chassis formed at an edge of a panel in a display device manufactured by using one substrate.

Display device includes: a display panel; a backlight unit formed under the display panel; and a side chassis bent over the display panel and under the backlight unit while enclosing an edge side of the display panel and the backlight unit, wherein an adhesive is filled inside the side chassis and in a space between the display panel and the backlight unit.

The display panel may include: an insulation substrate of one sheet; a microcavity formed on the one sheet insulation substrate and filled with a liquid crystal material; and a capping layer sealing the microcavity.

The side chassis may enclose all sides of the display panel and the backlight unit.

The side chassis may be formed while covering at least a portion of an upper surface of the display panel and at least a portion of a lower surface of the backlight unit.

The adhesive may be formed at two facing sides of the side chassis.

The adhesive may be formed at all sides of the side chassis.

The adhesive may include an epoxy.

A color filter formed under the microcavity may be further included.

The capping layer may be a color filter.

A first polarizer and a second polarizer respectively formed at a lower surface and an upper surface of the display panel may be further included.

The backlight unit may include a light source, a light guide, a diffuser sheet, and a reflection sheet.

The light source may be formed as an edge type in which the light source is disposed at the side of the backlight unit or a direct type in which the light source is disposed at a lower surface of the backlight unit.

A bottom chassis to receive the display panel and the backlight unit fixed by the side chassis and a top chassis formed while covering an upper surface of the bottom chassis may be further included.

The side chassis may cover at least a portion of the lower surface of the backlight unit and may be formed to be separated from the upper surface of the display panel by at least a predetermined distance.

The adhesive may further include a portion formed to cover a space where the display panel and the side chassis are separated and at least a portion of the upper surface of the display panel.

In another aspect, a display device includes: a display panel formed of one sheet of an insulation substrate; a backlight unit formed under the display panel; and a side chassis formed to be bent over the display panel and under the backlight unit while enclosing an edge side of the display panel and the backlight unit, wherein the side chassis is formed while covering at least a portion of an upper surface of the display panel and at least a portion of a lower surface of the backlight unit lower surface, and the adhesive is formed between the side chassis and the upper surface of the display panel and between the side chassis and the lower surface of the backlight unit.

As described above, according to the present disclosure, in the display device including the panel manufactured by using one substrate, the adhesive is filled inside the chassis formed at the edge of the panel such that damage to the display device may be prevented and durability may be improved.

### BRIEF DESCRIPTION OF THE DRAWINGS

FIG. 1 is a top plan view of a display device according to an example embodiment.

FIG. 2 is a cross-sectional view taken along a line II-II of FIG. 1.

FIG. 3 is a view of a cross-sectional structure of a panel according to an example embodiment.

FIG. 4 is a view of a cross-sectional structure of a panel according to another example embodiment.

FIG. 5 is a perspective view of a display device according to an example embodiment.

FIG. 6 is a perspective view of a display device according to another example embodiment.

FIG. 7 is a perspective view of a display device according to another example embodiment.

### DETAILED DESCRIPTION OF THE EMBODIMENTS

The present invention will be described more fully hereinafter with reference to the accompanying drawings, in which example embodiments are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

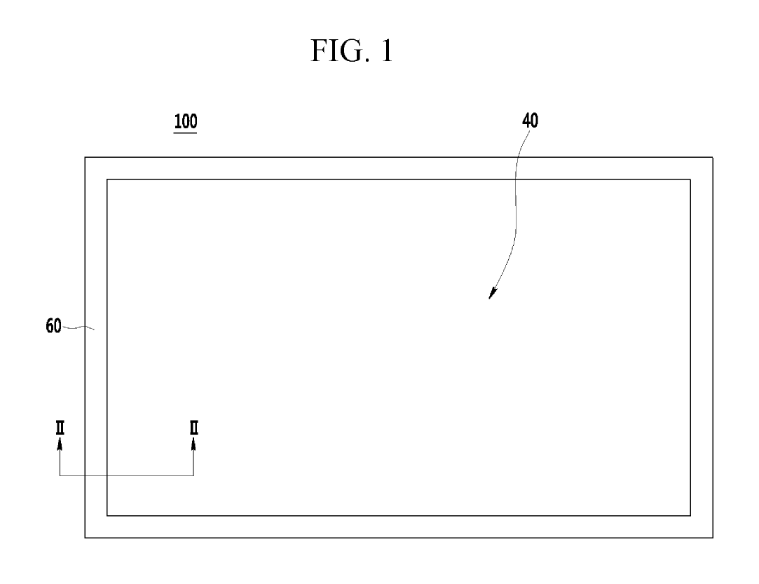

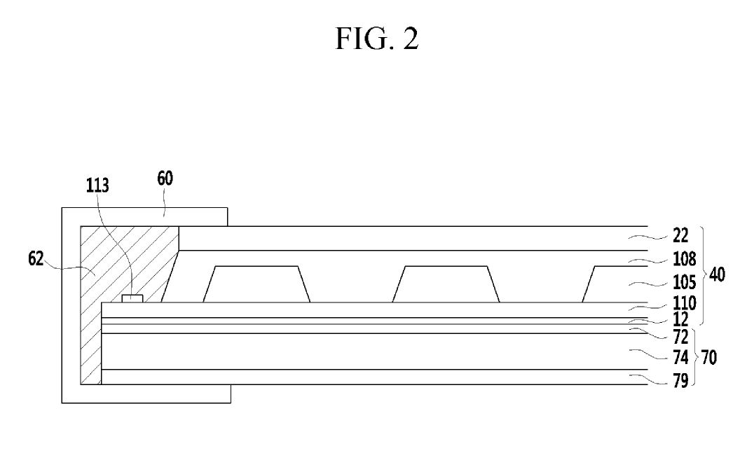

Now, a display device according to an example embodiment will be described with reference to FIG. 1 and FIG. 2.

FIG. 1 is a top plan view of a display device according to an example embodiment, and FIG. 2 is a cross-sectional view taken along a line II-II of FIG. 1.

Referring to FIG. 1 and FIG. 2, the display device according to an example embodiment includes a display panel 40 realizing an image, a backlight unit 70 providing light to the display panel 40, and a side chassis 60 fixing the backlight unit 70 and the display panel 40.

The side chassis 60 is bent to enclose all edges of the display panel 40 and the backlight unit 70.

That is, the side chassis 60 is bent on and down the display panel 40 and the backlight unit 70 while enclosing the edges of the display panel 40 and the backlight unit 70.

An adhesive 62 may be filled between the side chassis 60, and the display panel 40 and the backlight unit 70, to fix the constituent elements.

The display panel 40 controls the light transmittance from the backlight unit 70 according to an image signal to display an image, and the display device according to an example embodiment may be a liquid crystal display.

The display panel 40 of the display device according to an example embodiment includes a lower substrate 110, a microcavity 105 filled with a liquid crystal material formed on the lower substrate 110, and a capping layer 108 sealing the microcavity 105. The microcavity 105 is thus formed on only one substrate, the lower substrate 110.

In this case, the lower substrate 110 may be formed of a plastic material to have flexibility.

Also, a first polarizer 12 is attached to a lower surface of the lower substrate 110 and a second polarizer 22 is attached to an upper surface of the capping layer 108. A driver 113 may be formed beyond one edge of the second polarizer 22 and may be positioned on the lower substrate 110. The driver 113 generates a driving signal for driving the display panel 40 by using an external signal.

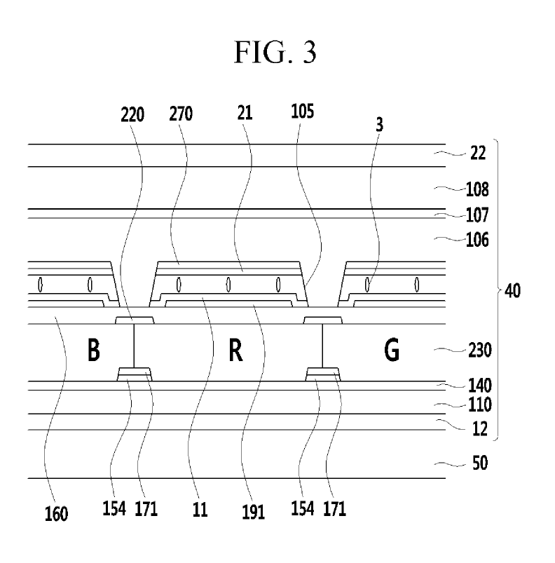

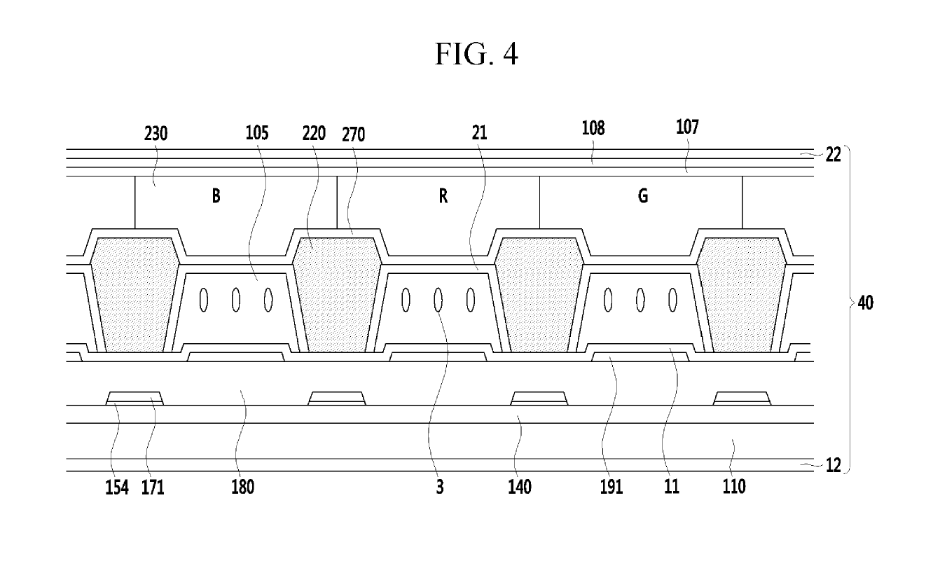

A detailed structure of the display panel 40 according to an example embodiment including only the lower substrate 110 will be described below with reference to FIG. 3 and FIG. 4.

The backlight unit 70 includes a light guide 74 (FIG. 2), which changes light emitted from a light source (not shown) into a planar light source to be supplied upwardly to the display panel 40. The backlight unit 70 also includes a diffuser sheet 72 positioned on the light guide 74, which scatters the light emitted from the light guide 74 to uniformly emit the light, and a reflection sheet 79 positioned under the light guide 74, which reflects light that has leaked to an opposite side of the display panel 40 to be transmitted to the light guide 74. A prism sheet (not shown) collecting the light diffused from the diffuser sheet 72 may be included on the diffuser sheet 72.

In an example embodiment, the light source (not shown) may be an edge type light source in which the light source is disposed at one edge of the light guide 74, or at a plurality of edges, or a direct type light source in which the light source is disposed under the light guide 74, however it is not limited thereto.

In this case, the light source may use a light emitting diode (LED), however the type of light source used is not limited thereto.

The side chassis 60 of the display device according to an example embodiment is formed to be bent twice, once across a portion of the display panel 40 and once across a portion of the backlight unit 70 while enclosing all edges of the display panel 40 and the backlight unit 70 to fix the display panel 40 and the backlight unit 70.

The side chassis 60 is formed so as to cover at least a portion of the upper surface of the display panel 40 and at least a portion of a lower surface of the backlight unit 70.

The side chassis 60 is formed of a material having a predetermined strength such as plastic or metal, and the adhesive 62 is filled in a space between the side chassis 60 and the display panel 40 and the backlight unit 70 disposed inside the side chassis 60, thereby firmly fixing the side chassis 60, the display panel 40, and the backlight unit 70.

The adhesive 62 may be a transparent or opaque adhesive, and may be formed so as to harden after filling the cavity when the adhesive 62 is in a liquid state. However, an adhesive of a solid state may be used, or an adhesive of an adhesion tape form may be used.

The adhesive 62 may include an epoxy.

In a case of a generally-used liquid crystal display formed of two sheet substrates including a liquid crystal layer formed between upper and lower substrates, although the adhesive 62 doesn't filled inside the side chassis 60, since the upper substrate and the lower substrate have the predetermined strength, they may be firmly fixed.

In contrast, in the case of the display panel 40 according to an example embodiment the display panel 40 is formed with only the lower substrate 110 and without an upper substrate, and the upper surface is only formed of the capping layer 108 of the organic material and the second polarizer 22 In such a display panel 40, the strength of the upper surface only formed of the capping layer 108 is weak, which is different from a liquid crystal display made of two substrates. As a result, the side chassis 60 may be separated from the display panel 40.

In particular, when the display panel 40 is bent to forma curved display device, the side chassis 60 may become separated from the display panel 40 according to an example embodiment in which the upper surface is formed of the capping layer 108 of a relatively soft material, such that the display device may be damaged.

Accordingly, by filling the adhesive 62 between the side chassis 60, and the display panel 40 and the backlight unit 70, damage to the display device due to separation of the display panel 40 from the side chassis 60 may be prevented through a method of firmly adhering the constituent elements to each other.

The adhesive 62 according to an example embodiment n may be formed along all edges of the display panel 40. Alternatively, the adhesive 62 may only be formed at the edge of the bending direction for formation of the curved display device as necessary.

The panel of the display device according to an example embodiment and another example embodiment will be described in detail with reference to FIG. 3 and FIG. 4.

FIG. 3 is a view of a cross-sectional structure of a panel according to an example embodiment, and FIG. 4 is a view of a cross-sectional structure of a panel according to another example embodiment.

First, referring to FIG. 3, the display device according to an example embodiment includes a liquid crystal panel between a first polarizer 12 and a second polarizer 22.

The liquid crystal panel includes the first polarizer 12, the substrate 110 disposed on the first polarizer 12, a plurality of gate lines (not shown), a gate insulating layer 140, a plurality of semiconductors 154, a plurality of data lines 171, and a plurality of color filters 230.

Each color filter 230 may display one of primary colors such as three primary colors of red, green, and blue. However, it is not limited to the three primary colors of red, green, and blue, and may display one of cyan, magenta, yellow, and white-based colors.

A plurality of light blocking members 220 and an interlayer insulating layer 160 are disposed on the color filters 230. The light blocking member 220 overlaps each data line 171. The interlayer insulating layer 160 covers the light blocking member 220 and an upper surface thereof is flat.

A pixel electrode 191 is disposed on the interlayer insulating layer 160, a first alignment layer 11 is disposed on the pixel electrode 191, a second alignment layer 21 is disposed at a part facing the first alignment layer 11, and a microcavity 105 is disposed between the first alignment layer 11 and the second alignment layer 21.

A liquid crystal material 3 including liquid crystal molecules is injected into the microcavity 105, and the microcavity 105 has a liquid crystal injection hole (not shown) through which the liquid crystal material 3 is injected. The liquid crystal injection hole (not shown) may be positioned at a side of the microcavity 105.

A common electrode 270 is disposed on the second alignment layer 21. The common electrode 270 is applied with a common voltage and generates an electric field along with the pixel electrode 191 applied with a data voltage, thereby determining a direction of the liquid crystal molecules positioned in the microcavity 105 between the two electrodes. The common electrode 270 forms a capacitor along with the pixel electrode 191 to maintain the applied voltage after the thin film transistor is turned off.

In the present example embodiment, the common electrode 270 is formed on the microcavity 105, however as another example embodiment, the common electrode 270 is formed under the microcavity 105 thereby driving the liquid crystal according to a coplanar electrode (CE) mode.

A roof layer 106 is disposed on the common electrode 270. The roof layer 106 has a supporting function such that the microcavity 105 as a space between the pixel electrode 191 and the common electrode 270 is formed. The roof layer 106 may include a photoresist, or other organic materials.

An insulating layer 107 made of a silicon nitride (SiNx) or a silicon oxide (SiOx) is disposed on the roof layer 106, and the capping layer 108 is disposed on the insulating layer 107.

The capping layer 108 covers the exposed liquid crystal injection hole of the microcavity 105 while filling a portion where the liquid crystal injection hole (not shown) is formed. The capping layer 108 includes the organic material or the inorganic material.

The second polarizer 22 is disposed on the capping layer 108.

Next, a display panel 40 according to another example embodiment applied with the display device will be described with reference to FIG. 4.

The display panel 40 according to the current example embodiment shown in FIG. 4 is substantially the same as the display panel 40 according to the example embodiment shown in FIG. 3, except for the position of the color filters 230 and the light blocking member 220.

As shown in FIG. 4, in the display panel 40 according to the current example embodiment, a plurality of color filters 230 are formed at an upper surface of the common electrode 270.

That is, each color filter 230 is formed at the position corresponding to the roof layer 106 of the display panel 40 according to the example embodiment shown in FIG. 3.

Each color filter 230 may display one of three primary colors such as red, green, and blue. However, it is not limited to the three primary colors such as red, green, and blue, and may display one of cyan, magenta, yellow, and white-based colors.

A passivation layer 180 made of an inorganic insulator such as a silicon nitride or a silicon oxide, an organic insulator, and a low dielectric insulator may be formed instead of the color filter 230 at the position where the color filter 230 was formed in the display panel 40 according to the example embodiment shown in FIG. 3.

Also, the light blocking member 220 may be formed to overlap the direction that the data line 171 extends, or may be formed while filling a groove between the microcavities 105.

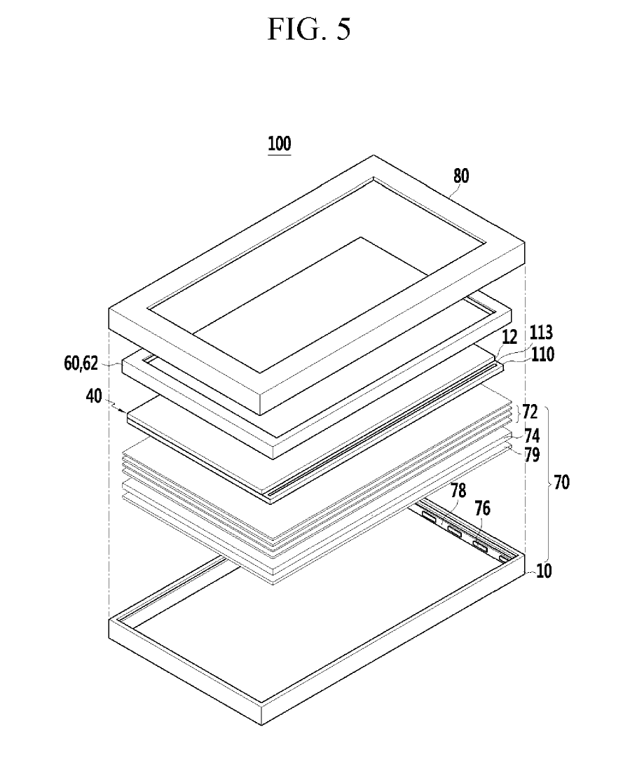

Next, the detailed structure of the entire display device according to an example embodiment will be described with reference to FIG. 5.

FIG. 5 is a perspective view of a display device 100 according to an example embodiment.

A backlight unit 70 supplying light to the display panel 40 includes a plurality of light sources 76 supplying the light, and the light sources 76 are arranged in parallel to the lateral portion of a bottom chassis 10, thereby emitting a large amount of light.

The structure of the display device 100 shown in FIG. 5 is an example, and the disclosure is not limited thereto. Accordingly, the present invention may be applied to a display device of other structures, and the arrangement shape of the light source may be various. For example, differently from the case in which the light source 76 is only disposed at one side to the bottom chassis 10 of FIG. 5, it may be disposed at a plurality of sides and a lower surface of the bottom chassis 10.

Also, the light source 76 may be a light emitting diode (LED), or various lamps such as a cold cathode fluorescent lamp (CCFL) may be disposed.

The display device 100 according to an example embodiment shown in FIG. 5 is largely formed of the backlight unit 70 disposed to be received inside the side chassis 60 and supplying the light and the display panel 40 displaying the image corresponding to the light.

Further, to fix and support them, a top chassis 80, a side chassis 60, and a bottom chassis 10 are coupled. However, the top chassis 80 may be omitted if necessary.

The backlight unit 70 supplies the light to the display panel 40 to improve the luminance while guiding the light, and the display panel 40 positioned on the backlight unit 70 may display the image.

The display panel 40 of the display device according to an example embodiment includes the lower substrate 110, the microcavity (not shown) filled with the liquid crystal material formed on the lower substrate 110, and the capping layer (not shown) sealing the microcavity, thereby only being formed of one lower substrate 110.

In this case, the lower substrate 110 may be formed of a plastic material to have flexibility.

Further, the first polarizer 12 and the second polarizer (not shown) adhered to the lower surface of the lower substrate 110 and the upper surface of the capping layer (not shown), and a driver 113 formed at one edge surface of the lower substrate 110 and generating a driving signal driving the display panel 40 by using an external signal, may be further included.

The backlight unit 70 to provide the uniform light to the display panel 40 is provided under the display panel 40.

The backlight unit 70 is adhered and fixed by the adhesive 62 filled inside the side chassis 60 that is received on the bottom chassis 10, and includes the plurality of light sources 76 as the backlight that is arranged and is separated from the side of the bottom chassis 10 by a predetermined distance to be fixed and installed, the reflection sheet 79 received to be adjacent to the bottom surface of the bottom chassis 10 and reflecting the light emitted from the light source 76 of the side of the bottom chassis 10, a light source holder 78 fixing and supporting the light source 76 at the rear surface of the light source 76, and the diffuser sheet 72 and the light guide 74 to provide the light to the display panel 40 by obtaining the luminance characteristic of the light from the light source 76.

The side chassis 60 of the display device according to an example embodiment is formed to enclose all edges of the display panel 40 and the backlight unit 70 to fix the display panel 40 and the backlight unit 70.

The side chassis 60 is formed while covering at least a portion of the upper surface of the display panel 40 and at least a portion of the lower surface of the backlight unit 70.

The side chassis 60 may be formed of the material having predetermined strength such as a plastic or a metal, and the adhesive 62 is filled at the space between the display panel 40 and the backlight unit 70 disposed inside the side chassis 60, thereby firmly fixing the side chassis 60, the display panel 40, and the backlight unit 70.

The adhesive 62 may be a transparent or opaque adhesive, or may include an epoxy.

The top chassis 80 is provided on the display panel 40 to prevent the display panel 40 and the backlight unit 70 fixed to the side chassis 60 from being separated from the bottom chassis 10. Although not shown in FIG. 5, a front case and a rear case are respectively positioned on the top chassis 80 and under the bottom chassis 10 such that the display device 100 is formed by coupling thereof, and in this case, the top chassis 80 may be omitted.

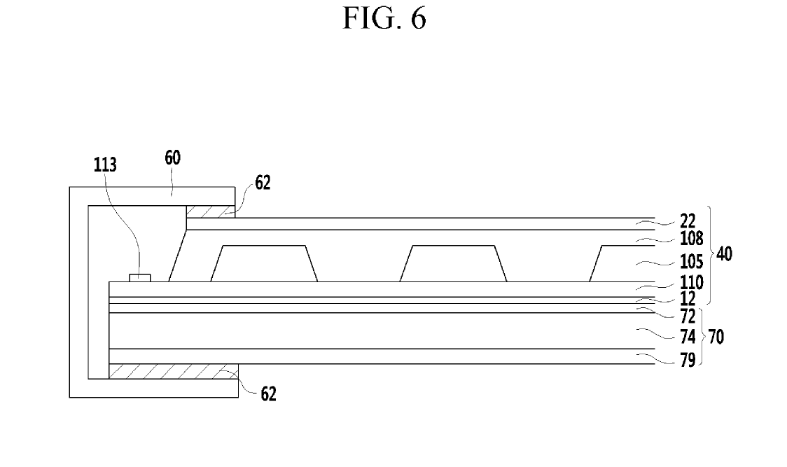

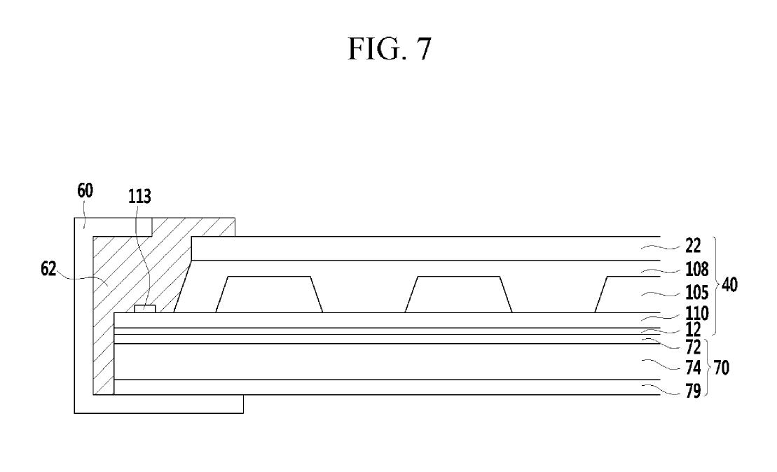

Hereinafter, an example variation will be described with reference to FIG. 6 and FIG. 7.

FIG. 6 and FIG. 7 are cross-sectional views of the display device according to another example embodiment.

First, the display panel 40 according to the current example embodiment shown in FIG. 6 is substantially the same as the display panel 40 according to the example embodiment shown in FIG. 2 except for the adhesive 62 such that the repeated description is omitted.

As shown in FIG. 6, the side chassis 60 fixing the display panel 40 and the backlight unit 70 according to the current example embodiment may be adhered to at least a portion of the upper surface edge of the display panel 40 and at least a portion of the lower surface edge of the backlight unit 70 by the adhesive 62.

The adhesive 62 may be the transparent or opaque adhesive, or may be a type in a liquid state that is filled and hardened, however it is not limited thereto, and a solid adhesive or an adhesive of an adhesion tape form may be used.

The adhesive 62 may include the epoxy.

Next, the display panel 40 according to another example embodiment shown in FIG. 7 is substantially the same as the display panel 40 according to the example embodiment shown in FIG. 2 except for the upper structure of the side chassis 60 and the adhesive 62 such that the repeated description is omitted.

As shown in FIG. 7, the side chassis 60 according to the current example embodiment encloses the partial surface of the lower surface edge of the backlight unit 70, however it does not enclose the edge surface of the upper surface of the display panel 40 and is formed to be separated by a predetermined distance.

That is, the upper surface of the side chassis 60 is protruded by a shorter length than the lower surface of the side chassis 60 to be separated from the display panel 40.

The adhesive 62 is filled between the side chassis 60, and the display panel 40 and the backlight unit 70, to fix the constituent elements like the example embodiment shown in FIG. 2.

Also, the adhesive 62 is additionally filled between the separation space of the side chassis 60 and the display panel 40, and the adhesive 62 is formed while penetrating at least a portion of the upper surface edge of the display panel 40.

In this case, the adhesive 62 may be the transparent or opaque adhesive, or may be formed of the type that the adhesive 62 of the liquid state is filled and hardened, and may include the epoxy.

When bending the display panel 40 to manufacture the curved display device by using the display panel 40 formed with one sheet substrate and including the capping layer 108 having the upper surface formed of the organic material, the pressure by the side chassis 60 is applied to the upper surface of the capping layer 108 such that the display device may be damaged.

However, according to the example embodiment shown in FIG. 7, the upper surface of the side chassis 60 covering the partial edge of the upper surface is partially separated from the display panel 40 and the adhesive 62 of the relatively soft material is filled to the separation portion to fix the display panel 40 and the side chassis 60, thereby preemptively preventing the pressure that may be applied to the upper surface of the display panel 40 by the side chassis 60.

As described above, in the display device according to an example embodiment, the adhesive is filled inside the chassis formed at the edge in the display device including the panel formed by using one substrate to prevent the damage of the display device, thereby improving the durability.

While example embodiments have been described in connection with what is presently considered to be practical example embodiments, it is to be understood that the disclosure is not limited to the disclosed embodiments, but, on the contrary, is intended to cover various modifications and equivalent arrangements included within the spirit and scope of the disclosure, including the appended claims.

<Description of symbols>

| | |
|---|---|
| 60: side chassis | 62: adhesive |
| 113: driver | 79: reflection sheet |
| 74: light guide | 72: optical sheet |
| 12, 22: first, second polarizer | 110: lower substrate |
| 105: microcavity | 108: capping layer |
| 11, 21: first, second alignment layer | 270: common electrode |
| 106: roof layer | 107: insulating layer |
| 230: color filter | 191: pixel electrode |
| 154: semiconductor | 180: passivation layer |
| 160: interlayer insulating layer | 40: display panel |
| 70: backlight | 76: light source |
| 10: bottom chassis | 80: top chassis |

What is claimed is:

1. A display device comprising:
a display panel;
a backlight unit formed under the display panel; and
a side chassis bent over the display panel and under the backlight unit while enclosing an edge side of the display panel and the backlight unit,
wherein an adhesive is filled inside the side chassis and in a space between the display panel and the backlight unit.

2. The display device of claim 1, wherein:
the display panel includes an insulation substrate of one sheet;
a microcavity formed on the one sheet insulation substrate and filled with a liquid crystal material; and
a capping layer sealing the microcavity.

3. The display device of claim 2, wherein
the side chassis encloses all sides of the display panel and the backlight unit.

4. The display device of claim 3, wherein
the side chassis is formed while covering at least a portion of an upper surface of the display panel and at least a portion of a lower surface of the backlight unit.

5. The display device of claim 4, wherein
the adhesive is formed at two facing sides of the side chassis.

6. The display device of claim 4, wherein
the adhesive is formed at all sides of the side chassis.

7. The display device of claim 4, wherein
the adhesive includes an epoxy.

8. The display device of claim 2, further comprising
a color filter formed under the microcavity.

9. The display device of claim 2, wherein
the capping layer is a color filter.

10. The display device of claim 2, further comprising
a first polarizer and a second polarizer respectively formed at a lower surface and an upper surface of the display panel.

11. The display device of claim 10, wherein
the backlight unit includes a light source, a light guide, a diffuser sheet, and a reflection sheet.

12. The display device of claim 11, wherein
the light source is formed as an edge type in which the light source is disposed at the side of the backlight unit or a direct type in which the light source is disposed at a lower surface of the backlight unit.

13. The display device of claim 11, further comprising:
a bottom chassis to receive the display panel and the backlight unit fixed by the side chassis; and
a top chassis formed while covering an upper surface of the bottom chassis.

14. The display device of claim 3, wherein
the side chassis covers at least a portion of the lower surface of the backlight unit and is formed to be separated from the upper surface of the display panel by at least a predetermined distance.

15. The display device of claim 14, wherein
the adhesive further includes a portion formed to cover a space where the display panel and the side chassis are separated and at least a portion of the upper surface of the display panel.

16. The display device of claim 15, wherein
the adhesive is formed at two facing sides of the side chassis.

17. The display device of claim 15, wherein
the adhesive is formed at all sides of the side chassis.

18. The display device of claim 15, wherein
the adhesive includes an epoxy.

19. A display device comprising:
a display panel formed of one sheet of an insulation substrate;
a backlight unit formed under the display panel; and
a side chassis formed to be bent over the display panel and under the backlight unit while enclosing an edge side of the display panel and the backlight unit,
wherein the side chassis is formed while covering at least a portion of an upper surface of the display panel and at least a portion of a lower surface of the backlight unit lower surface, and
the adhesive is formed between the side chassis and the upper surface of the display panel and between the side chassis and the lower surface of the backlight unit.

20. The display device of claim 19, wherein:
the display panel includes a lower substrate formed on the first polarizer;
a microcavity formed on the lower substrate and filled with the liquid crystal material;
a capping layer sealing the microcavity; and
a second polarizer formed on the capping layer, and
the backlight unit includes a light source, a light guide, a diffuser sheet, and a reflection sheet.
